(19) United States
(12) Patent Application Publication
(10) Pub. No.: US 2019/0296517 A1
(43) Pub. Date: Sep. 26, 2019

(54) LASER WITH A CONTROLLABLE OUTPUT WAVELENGTH

(71) Applicant: Huawei Technologies Co., Ltd., Shenzhen (CN)

(72) Inventor: Ian LEALMAN, Ipswich (GB)

(21) Appl. No.: 16/435,486

(22) Filed: Jun. 8, 2019

Related U.S. Application Data
(63) Continuation of application No. PCT/EP2016/080303, filed on Dec. 8, 2016.

(51) Int. Cl. H01S 3/08; H01S 3/10; H01S 3/00

(52) U.S. Cl. CPC H01S 3/08086; H01S 3/0085; H01S 3/10053

(57) ABSTRACT

A laser comprising a gain section and a plurality of gratings are provided. Each grating is coupled to the gain section to form a respective optical cavity that is capable of generating light of a particular wavelength. The laser also comprises a switch that is configured to select one of the plurality of gratings, such that the optical cavity formed by the gain section and the selected grating generates the light output of the laser. This provides a laser that is tunable between different wavelengths and offers a simple level of tuning control.

### CROSS-REFERENCE TO RELATED APPLICATIONS

This application is a continuation of International Application No. PCT/EP2016/080303, filed on Dec. 8, 2016, the disclosure of which is hereby incorporated by reference in its entirety.

### TECHNICAL FIELD

Embodiments of this invention relate to a laser that is capable of outputting different wavelengths.

### BACKGROUND

A laser is a device that emits light through amplifying electromagnetic radiation generated via stimulated emission. A basic laser can be formed from a gain section, which is configured to generate light via stimulated emission, and mirrors that form a cavity for reflecting and amplifying the generated light. Some lasers are wavelength-tunable, in which case the laser may be provided with two electrical inputs. A first input for providing a control current or voltage that determines the optical power and a second input for providing a control current or voltage that determines the optical wavelength.

There are different approaches that are currently used to realise tuneable lasers with a wide tuning range (e.g. a wavelength range of around 40 nm). These include devices such as superstructure grating Distributed Bragg Reflector (DBR) lasers. These lasers require a pair of complex gratings with multiple reflection peaks to realize tuning via a Vernier mechanism, in order to overcome the limited range of a simple grating DBR laser (which typically has a wavelength range of around 10 nm). This requires complex device characterization and control. Another possibility is to use an array of independently driven DBR lasers in conjunction with a waveguide combiner and output semiconductor optical amplifier (SOA). The SOA is required to overcome combiner losses. The resulting device has a large number of electrical contacts, making it complex to control and manufacture. An example of such a device is described in “Wavelength-Tunable Short-Cavity DBR Laser Array with Active Distributed Bragg Reflector” by Arimoto et al (see Journal of lightwave technology, Vol. 24, No 11, pp 4366-4371).

It is an object of the invention to provide an improved laser.

### SUMMARY

The foregoing and other objects are achieved by the features of the independent claims. Further implementation forms are apparent from the dependent claims, the description and the figures.

According to a first aspect, a laser is provided that comprises a gain section and a plurality of gratings. Each grating is coupled to the gain section to form a respective optical cavity that is capable of generating light of a particular wavelength. The laser also comprises a switch that is configured to select one of the plurality of gratings, such that the optical cavity formed by the gain section and the selected grating generates the light output of the laser. This provides a laser that is tunable between different wavelengths and that has a simple level of tuning control.

Each grating may form an optical cavity that is capable of generating light having a wavelength that is adjustable within a respective wavelength range. This provides a laser that is tunable within a range of wavelengths rather than being limited to discrete wavelengths.

The respective wavelength range for each optical cavity may be different from the wavelength ranges for the other optical cavities. This enables the laser to generate light over wider wavelength range than that achievable with a single grating.

The laser may comprise a single input that is configured to control a wavelength at which all the optical cavities formed by the plurality of gratings generate light within their respective wavelength ranges. This reduces the level of control electronics required and may also reduce the required tuning power.

The laser may be configured such that, when the switch is in a first switching state, light travelling in the optical cavity formed by the gain section and the grating selected by the first switching state interferes constructively, whereby the selected grating contributes to generating the light output of the laser. Light travelling in the respective optical cavities formed between the gain section and the non-selected gratings may interfere destructively, whereby the non-selected gratings do not contribute to generating the light output of the laser. This provides an effective technique for selecting one particular grating for providing the light output of the laser. It also controls the output wavelength of the laser.

The laser may be configured such that, when the switch changes from the first switching state to a second switching state, a different one of the plurality of gratings is selected and light travelling in the optical cavity formed by the gain section and the newly selected grating interferes constructively, whereby that newly selected grating contributes to generating the light output of the laser. Light travelling in the optical cavity formed by the gain section and the grating selected by the first switching state may interfere destructively, whereby the grating selected by the first switching state no longer contributes to generating the light output of the laser. This provides an effective technique for changing from one grating to another. It also enables the output wavelength of the laser to be changed from one wavelength to another.

The laser may comprise a first splitter, which is connected to two of the gratings. It may comprise a first path and a second path, which are both connected to the first splitter and configured to carry light between the gain section and the two gratings. It may also comprise a second splitter, which is connected to the first and second paths and the gain section. At least one of the first path and the second path may be configured to change the phase of the light that it carries relative to light carried by the other of the paths such that light travelling between the gain section and one of the gratings exits the first and second paths with a different phase difference between light from the first path and light from the second path than when that light enters the first and second paths. This structure is provides a mechanism for enabling constructive and destructive interference between light that has travelled via different paths.

One of the first path and the second path may be longer than the other path, that path thereby being capable of changing the phase of the light that it carries relative to light carried by the other path. This provides a simple mechanism for introducing a difference in phase between light that has travelled via the two paths.

One of the first path and the second path may comprise an electro-optic modulator that is controlled by the switch, that path thereby being capable of changing the phase of the light that it carries relative to light carried by the other path. This provides a mechanism for controlling a phase difference between light that has travelled via the two paths.

The electro-optic modulator may be configured such that, when a first voltage is applied to the switch, the phase difference between: (i) light carried by the first path between the gain section and one of the two gratings; and (ii) light carried by the second path between the gain section and said one of the two gratings, is such that that light interferes destructively on exiting the first and second paths, whereby said grating does not contribute to generating the light output of the laser. This provides a mechanism for deselecting one of the gratings, so that the wavelength of light that that grating's optical cavity is capable of generating does not appear in the laser output.

The electro-optic modulator may be configured such that, when a second voltage is applied to the switch, the phase difference between: (i) light carried by the first path between the gain section and one of the two gratings; and (ii) light carried by the second path between the gain section and said one of the two gratings, is such that that light interferes constructively on exiting the first and second paths, whereby said grating contributes to generating the light output of the laser. This provides a mechanism for selecting one of the gratings, so that the wavelength of light that that grating's optical cavity is capable of generating forms the laser output.

One of the first and second paths may be longer than the other path and the other of the first and second paths may comprise an electro-optic modulator. Thus, when zero voltage is applied to the switch, the difference in length between the first and second paths may cause light travelling between the gain section and a first one of the two gratings to interfere destructively on exiting the first and second paths and light travelling between the gain section and a second one of the two gratings to interfere constructively on exiting the first and second paths. When a non-zero voltage is applied to the switch, the electro-optic modulator may be configured to cause light travelling between the gain section and the first one of the two gratings to interfere constructively on exiting the first and second paths and light travelling between the gain section and the second one of the two gratings to interfere destructively on exiting the first and second paths. The laser may thereby be capable of selecting one of the two gratings for contributing to the light output of the laser when a zero voltage is applied to the switch. This reduces the required tuning power since power is only required by the switch for half of the desired wavelength tuning range.

The laser may comprise more than two gratings. It may be configured as a nested arrangement in which each grating is connected to the gain section via a respective route through the nested arrangement. The nested arrangement may have a plurality of levels in which each level comprises a first splitter configured to receive a light input from a respective pair of gratings, a first path and a second path, which are each connected to the first splitter, and a second splitter, which is connected to the first and second paths and to one output path. Each level may also comprise a switch that is configured to select one of the respective pair of gratings such that only the selected grating contributes to light output via the output path. The nested arrangement may be repeated until a level of the array comprises a single second splitter and a single output path, said single output path being connected to the gain section. This arrangement provides a laser which has a wider wavelength range.

The laser may comprise a Mach-Zehnder inferometer that is controlled by the switch. This provides a simple implementation of the laser.

The splitters may be one or more of: a multi-mode interference (MMI) structure, a directional coupler, a Y-splitter and a star coupler. Any of these provide an appropriate structure for directing light down different paths in the laser structure.

### BRIEF DESCRIPTION OF DRAWINGS

The present invention will now be described by way of example with reference to the accompanying drawings. In the drawings:

FIG. 1 shows an example of a laser according to an embodiment of the invention;

FIG. 2 shows an example of a laser according to an embodiment of the invention that has two gratings;

FIG. 3 illustrates a variation in wavelength versus tuning current for two example gratings; and

FIG. 4 shows an example of a laser according to an embodiment of the invention that has four gratings.

### DETAILED DESCRIPTION OF EMBODIMENTS

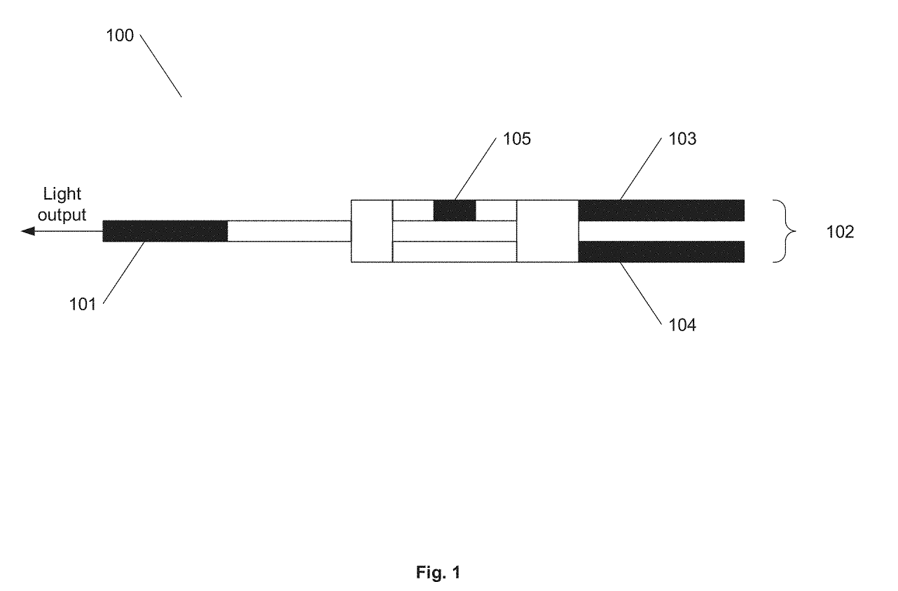

An example of a laser is shown in FIG. 1. The laser is shown generally at 100. The laser includes a gain section 101 and a plurality of gratings 102. Two gratings are illustrated in FIG. 1, but any number of gratings could be included in the laser (as will become apparent from some of the detailed embodiments described below). The gratings are coupled to the gain section. The coupling of the gain section with each respective grating forms an optical cavity. In the example of FIG. 1, one optical cavity is formed by the combination of gain section 101 and grating 103 and another optical cavity is formed by the combination of gain section 101 and grating 104. Each of the gratings has a defined wavelength or bandwidth, with the result that each optical cavity is capable of generating light having a wavelength that corresponds to the defined wavelength or bandwidth for its respective grating. So, the optical cavity formed by the combination of gain section 101 and grating 103 and is capable of generating light having a different wavelength from that which would be generated by the optical cavity formed by the combination of gain section 101 and grating 104.

The laser 100 also includes a switch 105 that is configured to select one of the plurality of gratings. The optical cavity that is formed by the gain section and the selected grating generates the light output of the laser. This enables the wavelength of light that is output by the laser to be controlled via the switch. In particular, the switch enables the wavelength of light output by the laser to be changed from a wavelength that is associated with one optical cavity to a wavelength that is associated with another.

Switch 105 may have two switching states. One switching state selects grating 103 and the other selects grating 104. The switch may have two or more switching states. In one switching state light travelling through one of the optical cavities interferes constructively while light travelling in the other optical cavity interferes destructively. This is reversed in the other switching state. The optical cavity in which light interferes constructively contributes to generating the light output of the laser. An optical cavity in which light interferes destructively does not contribute to generating the light output of the laser. Thus switching the switch from one switching state to another has the effect of changing which of the gratings contributes to the light output of the laser, which in turn controls the wavelength of the light output.

In one embodiment, each grating may be associated with a particular wavelength. This results in a wavelength-selectable laser, i.e. a laser that is capable of selecting between a number of discrete wavelengths. In another embodiment, the gratings may be tunable across a defined wavelength range or bandwidth. This results in a wavelength tunable laser.

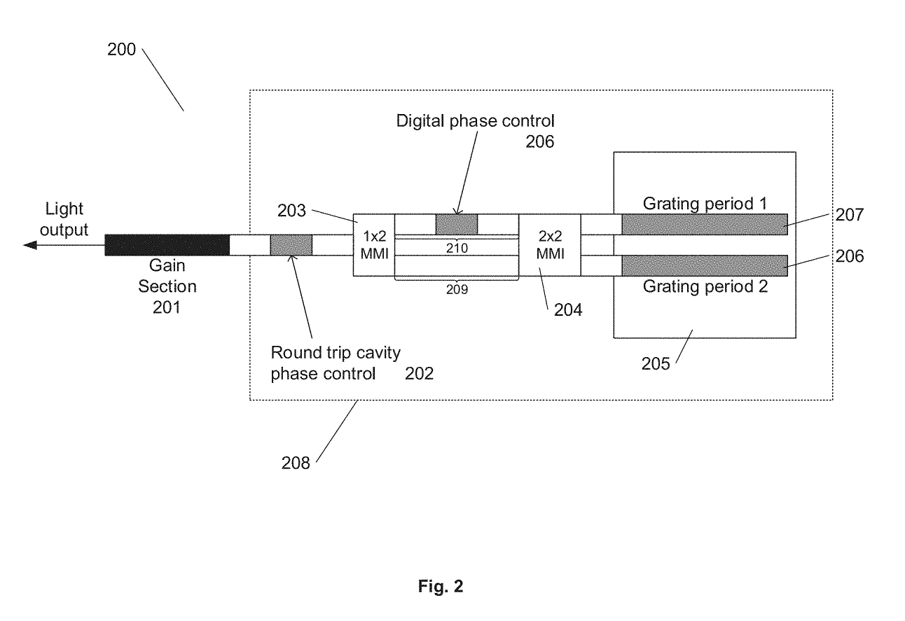

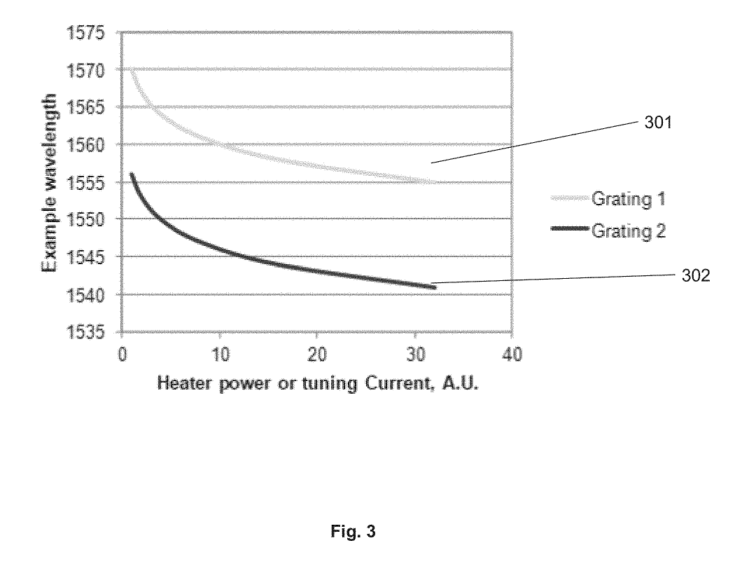

An example of a wavelength tunable laser is shown in FIG. 2. The wavelength tunable laser, shown generally at 200, has two gratings 207, 206. Each of the gratings 207, 206 has a defined wavelength range. The laser comprises a round trip cavity phase controller 202 to help stabilise the laser in a required lasing mode as the gratings 206/207 are tuned. In a preferred implementation, the wavelength ranges of the different gratings meet or overlap each other so that the laser is capable of outputting light over a continuous, expanded wavelength range. This is illustrated in FIG. 3, which shows examples of wavelength vs tuning current curves for grating 1 (207) and grating 2 (208). The graph shows that each grating has a defined wavelength range, as demonstrated by lines 301, 302. These two wavelength ranges overlap slightly, so that laser 200, which comprises both gratings, is capable of producing light across a continuous frequency range of around 1570 nm to around 1541 nm. If a certain output wavelength is desired, the appropriate grating is selected and then provided with the appropriate current input.

In one implementation, a plurality of gratings may be tuned via a single input. This is represented in FIG. 2 by control input 205. The input is configured to control the wavelength that is output by each of the plurality of gratings. The input could, for example, a single control heater or current source. Using a heater may be preferable to a current source, since this allows multiple closely-spaced gratings to be controlled simultaneously without increasing the heater power.

The laser 200 also has a gain section 201. The gratings and gain section are physically coupled together by a first splitter 204, a second splitter 203 and first and second paths 209, 210. The splitters may be configured to direct light down both paths. In other words, light may travel between the gain section 201 and grating 1 (207) via both the first path 210 and the second path 209. Similarly, light may travel between the gain section 201 and grating 2 (208) via both the first path 210 and the second path 209. The optical cavity formed by the combination of the gain section and grating 1 thus comprises both paths and both splitters, as does the optical cavity formed by the combination of the gain section and grating 2. One of the paths may configured to affect some property of the light travelling through it relative to light that travels through the other path. One property that can be altered is phase.

Either path may implement a phase-altering property. In the example of FIG. 2, the phase is altered directly by a digital phase control 206. The digital phase control may be controlled by or implement the switch 105 in the laser of FIG. 1. In one implementation, the digital phase control may be an electro-optic modulator (such as a heater) configured to alter phase, but any suitable component might be used. The digital phase control may be configured to change the phase of the light that is carried by the first path 210 relative to the light that is carried by the second path 209. The effect of this is to cause light travelling between the gain section and the respective gratings (207, 208) to exit the first and second paths with a different phase difference between the light in those two paths than when that light entered the two paths. In other words, a phase alteration occurs to light travelling along one path that is not matched in the light travelling along the other path. This phase difference affects light exiting the two paths, causing it to interfere constructively or to interfere destructively. This has the effect of selecting one of the gratings 207, 206 to contribute to the light output of the laser, which the other grating does not contribute to due to a phase difference between the two paths causing the light travelling through that grating's respective optical cavity to interfere destructively.

Typically, if the path lengths are the same then 50% of the light couples to each grating. If the phase controller is in the upper of the two paths 210, then adjusting the digital phase control to increase the phase/path length for that path by 90° will select the upper grating 207. Increasing the phase to 180° again splits the light by 50% to each grating. Increasing the phase again to 270° will select the lower grating 206.

Another option for implementing the phase-altering property of the two paths is to have one path permanently longer than the other. The longer distance travelled by light in one path causes an alteration in phase that is not matched by light that has travelled along the shorter path. This asymmetric path arrangement could be implemented together with a direct phase controller, such as digital phase control 206. Having paths that are permanently slightly offset in length can allow one grating to be selected when no power is supplied to the direct phase controller. The difference in physical length between the two paths causes light travelling through one optical cavity to interfere destructively and the light travelling through the other optical cavity to interfere constructively even when a zero voltage is applied to the phase controller. If the other optical cavity is to be selected, this situation can be reversed by applying a non-zero voltage to the phase controller. This offers a power-saving advantage, since it means that power is only required by the direct phase controller for half of the desired wavelength tuning range.

In one straightforward implementation, the laser shown in FIG. 2 may be implemented by a Mach-Zehnder inferometer (MZI) with a switch (e.g. a heater) in one arm to select one of a pair of gratings for providing the light output, those gratings being tuned by a single control heater or current source. This allows the wavelength of the laser to be determined by a single analogue wavelength control in conjunction with a digital switch. The splitters could be implemented by a multi-mode interference (MMI) structure, a directional coupler, a Y-splitter, a star coupler etc.

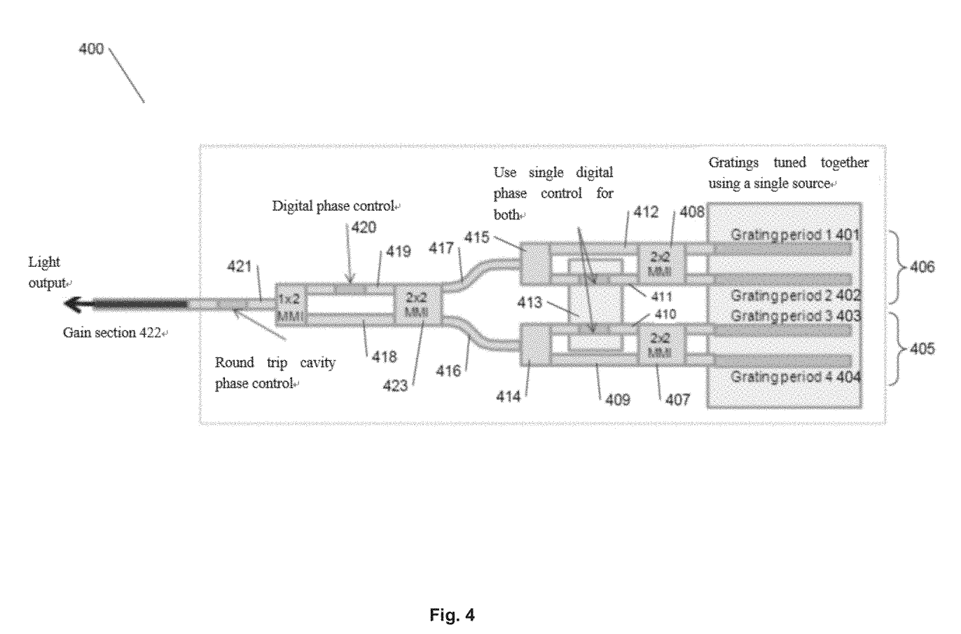

If a wider tuning range is required, then the laser may be provided with more than two gratings. These gratings may be configured as a nested array. An example of such a laser is shown in FIG. 4. This laser, which is shown generally at 400, comprises four gratings (401 to 404). These gratings are arranged in pairs 405, 406, and each neighbouring pair is connected to a respective shared first splitter 407, 408. That shared first splitter is in turn connected to respective first and second paths (409 to 412). Each pair of first and second paths is connected to a respective second splitter (414, 415). Each second splitter is then connected to one output path (416, 417).

Each respective arrangement of first and second paths and first and second splitters also incorporates a switch. In FIG. 4, the switches are implemented jointly by a shared switch 413 (e.g. such as a shared heater). This beneficially reduces the number of switches required. Each switch is configured to select one of the respective pairs of gratings (401 and 402, 403 and 404) that are connected to its particular set of first and second paths (411 and 412, and 409 and 410) for contributing to the light output via the output path (417, 416).

This arrangement of splitters and first and second paths is repeated with a third splitter (423) whose function is similar to that of the first splitter. It receives two input paths, each of which represent light from a particular grating (due to the selection that has been effected by the preceding switch 413), and it splits that light into two output paths 418, 419. A switch 420 is incorporated in these output paths, so that a further selection can take place. The result is a single output 421, which is connected to the gain section 422.

The nested arrangement shown in FIG. 4 can be extended to encompass any number of gratings. Although the number of gratings may be higher, the same principles apply. The laser is configured as a nested array in which each grating is connected to the gain section via a respective route through the array. The array has a plurality of levels. In the example of FIG. 4, the array has two levels. Each level comprises a first splitter, a first path and a second path, which are each connected to the first splitter, and a second splitter, which is connected to the first and second paths and an output path. The first splitter in each level is configured to receive light input from a respective pair of gratings. That could be because the first splitter is connected to the gratings themselves, or because it is connected to a pair of output paths from a preceding level of the array. The second splitter in each level is configured to output light via the output path. Each level also comprises a switch configured to select one of the respective pair of gratings for contributing to light that is output via the output path. This nested arrangement is repeated until a level of the array comprises a single second splitter and a single output path, which is connected to the gain section. In this way, by appropriately configuring the switches at each level of the array, a single grating can be selected to contribute to the light output of the laser in accordance with the principles of constructive and destructive interference described above.

It is preferable for the paths in the arrangements described above to be kept as short as possible so that the free spectral range is as large as possible. This helps to ensure that only one of the possible lasing modes from the roundtrip of the selected optical cavity is excited at any one time. This is helpful to maintain device stability as the device ages.

A device such as that shown in FIGS. 1, 2 and 4 could be realized with all the device being fabricated in the same material, e.g. from a monolithic source. An example of a suitable material might include a III-V material such as Indium Phosphide. The device could also be realised with the gain section implemented in one material, such as a III-V material, and most of the sections being implemented in a different material to make a hybrid laser. Those sections could, for example, be formed from silicon. This is represented in FIG. 2 by dashed line 208, where the tuning section inside the dashed box could be monolithically integrated with the gain section or could be a separate hybrid part.

The concepts described above provide a widely tuneable laser that offers a simpler level of tuning control (and possibly lower tuning power) when compared to the current range of tuneable lasers currently commercially available. This laser has the potential to reduce the cost incurred in the characterisation of the device in addition to the reducing the level of control electronics required at the module level.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A laser comprising:
a gain section;
a plurality of gratings, each coupled to the gain section to form a respective optical cavity that is capable of generating light of a particular wavelength; and
a switch configured to select one of the plurality of gratings such that the respective optical cavity formed by the gain section and the selected grating generates a light output of the laser.

2. The laser according to claim 1, wherein each grating forms an optical cavity that is capable of generating light having a wavelength that is adjustable within a respective wavelength range.

3. The laser according to claim 2, wherein the respective wavelength range for each optical cavity is different from the wavelength ranges for the other optical cavities.

4. The laser according to claim 2, further comprising:
a single input, configured to control a wavelength at which all the optical cavities formed by the plurality of gratings generate light within their respective wavelength ranges.

5. The laser according to claim 1, wherein when the switch is in a first switching state, the laser is configured to:
cause light travelling in the respective optical cavity formed by the gain section and the grating selected by the first switching state to interfere constructively, whereby the selected grating contributes to generating the light output of the laser; and
cause light travelling in respective optical cavities formed between the gain section and the non-selected gratings to interfere destructively, whereby the non-selected gratings do not contribute to generating the light output of the laser.

6. The laser according to claim 5, wherein when the switch changes from the first switching state to a second switching state, the laser is configured to:
select a different one of the plurality of gratings;
cause light travelling in the optical cavity formed by the gain section and the newly selected grating to interfere constructively, whereby the newly selected grating contributes to generating the light output of the laser; and
cause light travelling in the optical cavity formed by the gain section and the grating selected by the first switching state to interfere destructively, whereby the grating selected by the first switching state no longer contributes to generating the light output of the laser.

7. The laser according to claim 1, further comprising:
a first splitter, which is connected to two of the gratings;
a first path and a second path, which are both connected to the first splitter and configured to carry light between the gain section and the two gratings; and
a second splitter, which is connected to the first and second paths and the gain section;
wherein at least one of the first path and the second path is configured to change a phase of the light that the at least one of the first path and the second path carries and is relative to light carried by the other of the paths, such that light travelling from the gain section to one of the gratings enters the first and second paths with a first phase difference and exits the first and second paths with a second phase difference, the first phase difference being a phase difference between light entering the first path and light entering the second path, the second phase difference being a phase difference between light from the first path and light from the second path, wherein the second phase difference differs from the first phase difference.

8. The laser according to claim 7, wherein one of the first path and the second path is longer than the other path, the longer path thereby is capable of changing the phase of the light that the longer path carries and is relative to light carried by the other path.

9. The laser according to claim 7, wherein one of the first path and the second path comprises an electro-optic modulator that is controlled by the switch, the path comprising the electro-optic modulator thereby is capable of changing the phase of the light that the path electro-optic modulator carries and is relative to light carried by the other path.

10. The laser according to claim 9, wherein when a first voltage is applied to the switch, the electro-optic modulator is configured to cause the phase difference between: (i) light carried by the first path between the gain section and one of the two gratings, and (ii) light carried by the second path between the gain section and the one of the two gratings, to be that the light interferes destructively on exiting the first and second paths, whereby the grating does not contribute to generating the light output of the laser.

11. The laser according to claim 9, wherein when a second voltage is applied to the switch, the electro-optic modulator is configured to cause the phase difference between: (i) light carried by the first path between the gain section and one of the two gratings, and (ii) light carried by the second path between the gain section and the one of the two gratings, to be that the light interferes constructively on exiting the first and second paths, whereby the grating contributes to generating the light output of the laser.

12. The laser according to claim 7, wherein one of the first and second paths is longer than the other path and the other of the first and second paths comprises an electro-optic modulator; and
when zero voltage is applied to the switch, the difference in length between the first and second paths causes light travelling between the gain section and a first one of the two gratings to interfere destructively on exiting the first and second paths, and light travelling between the gain section and a second one of the two gratings to interfere constructively on exiting the first and second paths;
when a non-zero voltage is applied to the switch, the electro-optic modulator is configured to cause light travelling between the gain section and the first one of the two gratings to interfere constructively on exiting the first and second paths, and light travelling between the gain section and the second one of the two gratings to interfere destructively on exiting the first and second paths; and
the laser is capable of selecting one of the two gratings for contributing to the light output of the laser when a zero voltage is applied to the switch.

13. The laser according to claim 1, wherein the laser comprises more than two gratings and is configured in a nested arrangement in which each grating is connected to the gain section via a respective route through the nested arrangement, the nested arrangement having a plurality of levels in which each level comprises:
a first splitter configured to receive a light input from a respective pair of gratings;
a first path and a second path, which are each connected to the first splitter;
a second splitter, which is connected to the first and second paths and to one output path; and
another switch, configured to select one grating of the respective pair of gratings such that only the selected grating contributes to light output via the output path;
wherein the nested arrangement is repeated until a level of an array comprises a single second splitter and a single output path, and the single output path is connected to the gain section.

14. The laser according to claim 1, further comprising: a Mach-Zehnder inferometer that is controlled by the switch.

15. The laser according to claim 7, wherein the first splitter and the second splitter are one or more of: a multi-mode interference (MMI) structure, a directional coupler, a Y-splitter and a star coupler.
